(19) United States
(12) Patent Application Publication
(10) Pub. No.: US 2003/0131686 A1
(43) Pub. Date: Jul. 17, 2003

(54) Powershift transmission with hydrodynamical and optional mechanical power distribution

(76) Inventor: Tilo Huber, Passau (DE)

Correspondence Address: DAVIS & BUJOLD, P.L.L.C., FOURTH FLOOR, 500 N. COMMERCIAL STREET, MANCHESTER, NH, 03101-1151, US

(21) Appl. No.: 10/314,109

(22) Filed: Dec. 6, 2002

(30) Foreign Application Priority Data
Jan. 17, 2002 (DE) 102 01 590.2

(51) Int. Cl. F16H 3/093

(52) U.S. Cl. 74/664; 74/732.1; 74/331

(57) ABSTRACT

A powershaft transmission (1) with a hydrodynamical and a mechanical power distribution, especially one multi-gear powershift transmission as a reversing transmission for construction machinery, having at least two input shaft (2, 4), one of said input shafts (2) being connected with a turbine section of a torque converter and a second input shaft (4) being connected with the rotational speed of an engine via the direct through drive, at least one output shaft (32) and several countershafts (6, 7, 8, 9) having fixed wheels and gear clutches distributed thereon idler wheels to form several countershaft units (KR, KV, K1, K2, K3, K4) for gear and direction shifting, the countershaft unit (K4) being designed as a gear splitter which divides the ratios of the countershaft units (K1, K2, K3) and the countershaft unit (K4) being disposed coaxially upon the input shaft (2, 4).

According to the preamble of claim 1, the invention relates to a multi-gear powershift transmission with a hydrodynamical and an optional mechanical power distribution, especially one such multi-gear powershift transmission as a reversing transmission for construction machinery.

Powershift reversing transmissions are used in many different vehicles of the construction machinery branch. Typical examples of use are in fork lift trucks, excavator and wheel loaders, telescopic handlers and also in mobile cranes. The multiplicity of vehicles in this area requires a great amount of adaptation capacity in the used transmission since the installation and utilization conditions in the different vehicles can be widely different.

The installation space available, for example, can be extremely small. Different center distances can also appear between the transmission input shaft and the transmission output shaft. Depending on the type of vehicle a specific center distance is accordingly required between the input and output shafts of the transmission. Besides, in most areas of utilization at least one power take off unit is needed, for example, for the hydraulic system of the mobile machinery. The problems that a reversing transmission has to solve are accordingly very differently determined by the type of construction of the vehicle. Said requirements must be met within the axial length and width of the transmission. A future requirement of a powershift transmission with a hydrodynamical power distribution will also be an improved effectiveness, mainly when used with high services. In many utilizations, an additional mechanical power distribution can be an alternative to an often costly converter lock-up clutch.

U.S. Pat. No. 6,186,029 B1 has disclosed a powershift reversing transmission having a first part with first and second input shafts and one output shaft. The first input shaft of this prior art can be combined with a pump drive of a torque converter whereas the second input shaft can optionally be combined with a turbine of the torque converter so that it is possible to select separate drive paths with powershift clutches via the torque converter or via a direct through drive from an engine to a transmission output. The drive path, via the turbine section of the torque converter, is designated as a hydrodynamical power distribution and the drive path, via the direct through drive, as a mechanical power distribution. A second part of the transmission of this prior art has clutches and gear elements for different forward and reverse gears of the powershift reversing transmission. Said transmission of the prior art can also be operated as a retarder. By the arrangement of gear clutches, fixed wheels and idler wheels on several countershafts of this prior art, long and short center distances can be implemented, different combinations of countershafts taking part in the power transmission according to the gear desired. Accordingly for implementing in this prior art center distances different from each other, shaft arrangements different from each other are provided. But in this prior art, the limited flexibility of the gear ratios and of the total ratio is disadvantageous, the total ratio being low. Besides, the flexibility of the center distances, of the arrangement of input and output and of the PTO is not satisfactory.

The problem to be solved by this invention is to provide an efficient, multi-gear powershift transmission with a hydrodynamical and an optional mechanical power distribution at low cost which can be adapted to different installation situations, has an arrangement of shafts that is flexible and thus suitable for bridging different center distances and requires only a few added parts for adaptation to a specific installation situation.

This problem is solved with a multi-gear powershift transmission with the features of claim 1 and a multi-gear transmission with the features of claim 8.

According to the invention, a powershift transmission with a hydrodynamical and a mechanical power distribution is provided, especially one such multi-gear powershift transmission as a reversing transmission for construction machinery. At least one output shaft and several countershafts having idler wheels, fixed wheels and gear clutches distributed thereon form several countershaft units for shifting gear and direction. At least two input shafts are provided, one of said input shafts being connected with a turbine section of a torque converter and belonging to the hydrodynamical power distribution and a second input shaft being connected, via the direct through drive, with the rotational speed of an engine and belonging to the optionally engageable, mechanical power distribution. According to the invention, the countershaft unit K4 is designed as a gear splitter which divides the ratio steps of the countershaft units K1, K2, K3 and is situated coaxially on the input shafts. With the inventive, structurally simple powershift transmission, by virtue of the arrangement of the countershaft unit K4 upon the input shafts, the number of parts and thus the construction cost are reduced together with improved flexibility of the gear ratios and higher total ratio compared to the known prior art.

According to the invention, the differences of the ratios of the countershaft units K1, K2, K3 during operation are divided by the countershaft unit K4, via the optional mechanical power distribution, so that the change from hydrodynamical to mechanical power distribution and vice versa takes place for each gear shift, it being possible to select arbitrarily the overlapping between the ratios of the mechanical and of the hydrodynamical power distribution with the ratio of the countershaft unit K4.

During operation of the countershaft unit K4, the turbine section of the torque converter is separated from the output shaft so that losses from the torque converter are prevented and the efficiency of the inventive powershift transmission is improved.

According to a preferred embodiment of the invention, the powershift transmission has a power take-off, such as a PTO, coaxially with the input shafts. An engine-dependent PTO is preferably used.

The individual shafts of the inventive powershift transmission are combined to form a reversing transmission unit KV, KR, K4 and a gear transmission unit K1, K2, K3, the reversing transmission unit being provided on any desired side of the input shaft and the gear transmission unit attaching to the reversing transmission unit so that, in relation to the input shaft, the reversing transmission unit and the gear transmission unit are situated consecutively upon one side of the output shaft. The gear transmission unit is preferably attached to the countershaft unit of the reverse gear.

According to another preferred embodiment of the invention, the clutch of the countershaft unit of the fourth gear K4 drives, via an uncoupled wheel, into the constant so that the construction of the clutches of the countershafts KV and KR can be fundamentally identical.

The flexible arrangement of the shafts can be obtained without having to exchange the components involved in the power flow. A high amount of re-usability of components is thus ensured.

For vehicles which required the bridging of great distances by the transmission between input and output, a long distance variant can be provided such as can be implemented with a power divider transmission, for example.

According to the invention there is in addition provided a powershift transmission with a hydrodynamical power distribution, especially one multi-gear power transmission as a reversing transmission for construction machinery. At least one output shaft and several countershafts with idler wheels, fixed wheels and gear clutches distributed upon them form several countershaft units for gear and direction selection. At least one input shaft is provided which is connected with a turbine section of a torque converter and belongs to the hydrodynamical power distribution. According to the invention, the countershaft unit K4 is designed as a gear splitter and disposed coaxially upon the input shafts. With the inventive, structurally simple powershift transmission, because of the arrangement of the countershaft unit K4 upon the input shafts, the number of parts and thus the construction cost are reduced with improved flexibility of the gear ratio and higher total ratio compared to the known prior art. According to the invention, the difference of the ratios of the countershaft units K1, K2, K3 during operation is divided by the countershaft unit K4 via the optional hydrodynamical power distribution, it being possible to select arbitrarily the overlapping between the ratios with the ratio of the countershaft unit K4.

A preferred embodiment of the invention is explained in detail herebelow with reference to a drawing. The drawing shows:

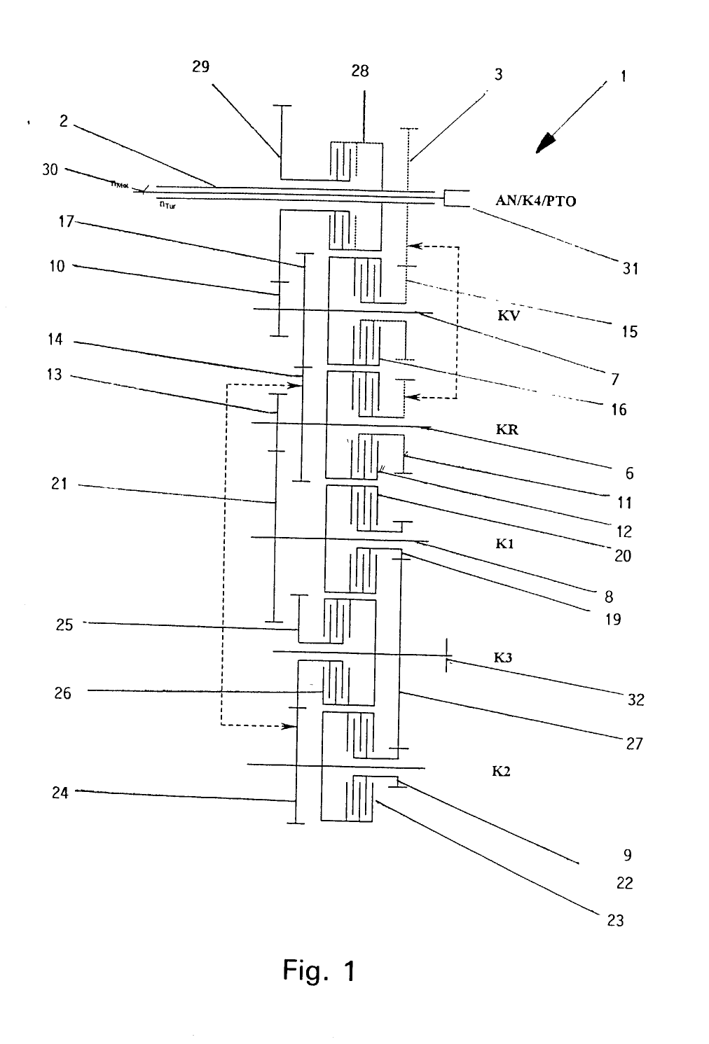

FIG. 1 is a transmission diagram of a multi-gear powershift transmission with a hydrodynamical power distribution; and

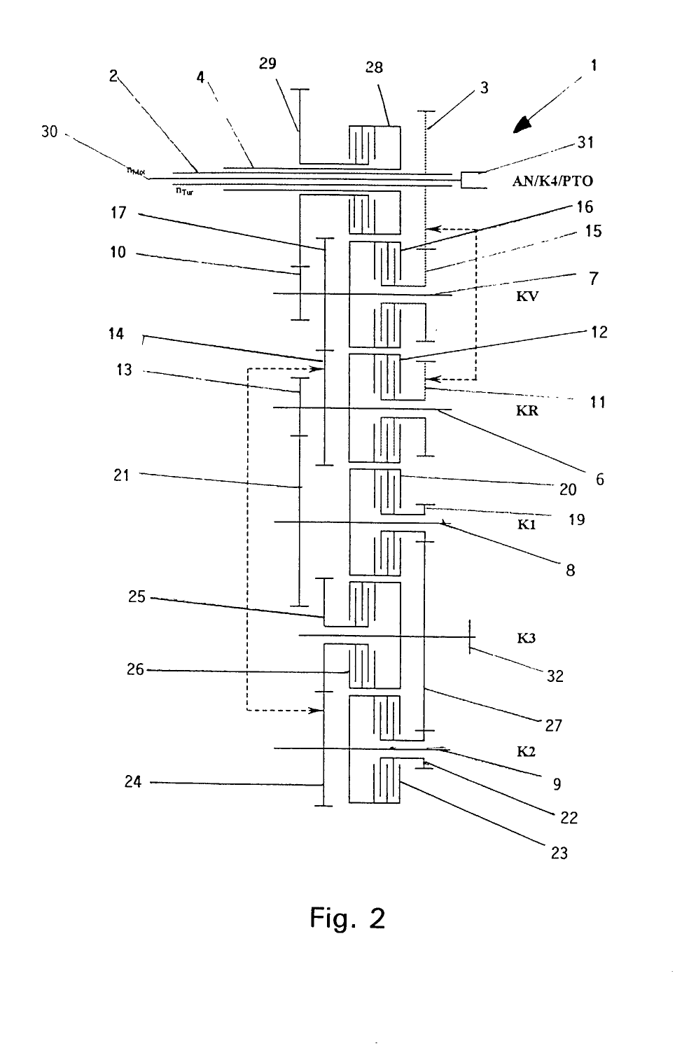

FIG. 2 is a transmission diagram of a multi-gear powershift transmission with hydrodynamical and mechanical power distributions according to this invention.

FIG. 1:

A multi-gear powershift transmission 1 has a hollow shaft with a fixed wheel 3 as an input shaft. The hollow shaft 2 is driven by a turbine section of a torque converter (not shown) and belongs to a hydrodynamical power distribution. The powershift transmission 1 has countershafts 6, 7 and 9 upon which are respectively situated fixed wheels, idler wheels and clutch elements forming therewith several countershaft units. The countershaft unit for the reverse gear KR is formed by the countershaft 6, the idler wheel 11, the clutch element 12 and the fixed wheels 13 and 14. The countershaft unit for the forward gear KV is formed by the countershaft 7, the idler wheel 15, the clutch element 16 and the fixed wheels 10 and 17. The countershaft unit for the first gear K1 is formed by the countershaft 8, the idler wheel 19, the clutch element 20 and the fixed wheel 21. The countershaft unit for the second gear K2 is formed by the countershaft 9, the idler wheel 22, the clutch element 23 and the fixed wheel 24. The countershaft unit for the third gear K3 is formed by the output shaft 32, the idler wheel 25, the clutch element 26 and the fixed wheel 27.

The K4 countershaft unit has a hollow shaft 2 as a countershaft, the clutch element 28 and the uncoupled wheel 29. The uncoupled wheel 29 meshes with the fixed wheel 10 of the countershaft unit KV.

A central shaft 30 is connected to a power take-off 31 of a PTO by a direct through drive.

From the diagram in FIG. 1 the expert can easily understand the mode of operation of the gear wheels and clutches to shift the different gears and the corresponding power flow. Therefore, it is not necessary to discuss this further.

FIG. 2:

Corresponding features are designated with the reference numerals of FIG. 1. A multi-gear powershift transmission 1 has an input shafts an inner hollow shaft 2 with a fixed wheel 3 and an outer hollow shaft 4. The inner hollow shaft 2 is driven by a turbine section of a torque converter (not shown) and belongs to a hydrodynamical power distribution and the outer hollow shaft 4 is driven at the rotational speed of an engine (not shown) via the direct through drive, and belongs to a mechanical power distribution.

The powershift transmission 1 has countershafts 6, 7, 8 and 9 upon which are respectively situated fixed wheels, idler wheels and clutch elements forming therewith several countershaft units. The countershaft unit for the reverse gear KR is formed by the countershaft 6, the idler wheel 11, the clutch element 12 and the fixed wheels 13 and 14. The countershaft unit for the forward gear KV is formed by the countershaft 7, the idler wheel 15, the clutch element 16 and the fixed wheels 10 and 17. The countershaft unit for the first gear K1 is formed by the countershaft 8, the idler wheel 19, the clutch element 20 and the fixed wheel 21. The countershaft unit of the second gear K2 is formed by the countershaft 9, the idler wheel 22, the clutch element 23 and the fixed wheel 24. The countershaft unit for the third gear K3 is formed by the output shaft 32, the idler wheel 25, the clutch element 26 and the fixed wheel 27.

The K4 countershaft unit has the outer hollow shaft 4 as a countershaft, the clutch element 28 and the uncoupled wheel 29. The uncoupled wheel 29 meshes with the fixed wheel 10 of the countershaft unit KV.

A central shaft 30 is connected to a power take-off 31 of a PTO by a direct through drive.

The countershaft units KV and KR are operated via the hydrodynamical power distribution. The differences of the ratios of the countershafts units K1, K2, K3 are divided during operation by the countershaft unit K4, via the optional mechanical power distribution, so that the reversal from hydrodynamical to mechanical power distribution and vice versa for each gear change takes place, it being possible to select arbitrarily the overlapping between the ratios of the mechanical and hydrodynamical power distributions with the ratio of the countershaft unit K4.

The countershaft units KV, KR and K4 form a reversing transmission unit and the countershaft units K1, K2 and K3 form a gear transmission unit, the countershaft units of the reversing transmission unit being provided on one side next to the input shafts 2, 4 and the countershaft units of the gear transmission unit attaching to the countershaft unit KR of the reverse gear.

### REFERENCE NUMBERALS

1 powershift transmission

2 input shaft

3 fixed wheel

4 input shaft

5-

6 countershaft

7 countershaft

8 countershaft

9 countershaft

10 fixed wheel

11 idler wheel

12 clutch element

13 fixed wheel

14 fixed wheel

15 idler wheel

16 clutch element

17 fixed wheel

19 idler wheel

20 clutch element

21 fixed

22 idler wheel

23 clutch element

24 fixed wheel

25 idler wheel

26 clutch element

27 fixed wheel

28 clutch element

29 uncoupled wheel

30 central shaft

31 PTO

32 output shaft

KV countershaft unit forward gear

KR countershaft unit reverse gear

K1 countershaft unit first gear

K2 countershaft unit second gear

K3 countershaft unit third gear

K4 countershaft unit splitter

AN input shaft

1. Powershift transmission (1) with hydrodynamical and mechanical power distribution, especially one such multi-gear powershift transmission as reversing transmission for construction machinery having at least two input shaft (2, 4), one of said input shafts (2) being connected with a turbine section of a torque converter and a second input shaft (4) being connected via the direct through drive with the rotational speed of an engine, at least one output shaft (32) and several countershafts (6, 7, 8m 9) with idler wheels, fixed wheels and gear clutches distributed thereon which form several countershaft units (KR, KR, K1, K2, K3, K4) for gear and direction shifting and characterized in that said countershaft unit (K4) is designed as gear splitter which divides the gear ratios of said countershaft units (K1, K2, K3)and the countershaft unit (K4) is disposed coaxially upon said input shafts (2, 4).

2. Powershift transmission (1) according to claim 1, characterized in that during the operation of said countershaft unit (K4) the turbine section of the torque converter is separated from said output shaft (32).

3. Powershift transmission (1) according to claim 1, characterized in that coaxially to said input shafts (2, 4) a power take-off (31) such as a PTO is provided.

4. Powershift transmission (1) according to claim 1, characterized in that the individual shafts are combined to form a reversing transmission unit (KV, KR, K4) and a gear transmission unit (K1, K2, 13), said reversing gear unit being provided in any desired side of said input shafts (2, 4) and said gear transmission unit attaching to said reversing transmission unit so that said reversing transmission unit and said gear transmission unit, in relation to said input shafts (2, 4), are disposed consecutively upon one side of said input shafts.

5. Powershift transmission (1) according to any one of the preceding claims, characterized in that to said output shaft (32) a power divider transmission can be attached.

6. Powershift transmission (1) according to any one of the preceding claims, characterized in that the clutch of said countershaft unit of the fourth gear (K4) enters in the constant via an uncoupled wheel.

7. Powershift transmission (1) according to claim 3, characterized in that said power take-off (31) is engine dependent.

8. Powershift transmission (1) with hydrodynamical power distribution, especially one such multi-gear powershift transmission as reversing transmission for construction machinery, having at least one input shaft (2) connected with a turbine section of a torque converter, at least one output shaft (32) and several countershafts (6, 7, 8, 9) having distributed thereon idler wheels, fixed wheels and gear clutches which form several countershaft units (KR, KV, K21, K2, K3, K4) for gear and direction shifting and characterized in that said countershaft unit (K4) is designed as gear splitter for said countershaft units (K1, 2, I3) and said countershaft unit (K4) is disposed coaxially on said input shafts (2, 4).
